(19) United States
(12) Patent Application Publication
(10) Pub. No.: US 2008/0068112 A1
(43) Pub. Date: Mar. 20, 2008

(54) Rod-loaded radiofrequency cavities and couplers

(76) Inventors: David U.L. Yu, Rancho Pals Vrds, CA (US); Alexei V. Smirnov, Rancho Palos Vrds, CA (US)

Correspondence Address: Dr. David U.L. Yu;DULY Research Inc, 1912 MacArthur Street, Rancho Palos Verdes, CA, 90275-1111, US

(21) Appl. No.: 11/522,185

(22) Filed: Sep. 14, 2006

(51) Int. Cl. H01P 7/06

(52) U.S. Cl. 333/228; 333/230

(57) ABSTRACT

This invention relates to radiofrequency (rf) cavities and couplers that comprise metallic or dielectric rods to provide specified concentration of field patterns for the operating modes in the interaction region, for applications in particle accelerators, pulsed rf power sources, amplifiers, mode converters and power couplers.

### GOVERNMENT RIGHTS

This invention was made with government support under Grant No. DE-FG03-02ER83400 and Grant No. DE-FG02-03ER83845 awarded by the U.S. Energy Department. The government may have certain rights in the invention.

### BACKGROUND OF THE INVENTION

1. Field of the Invention

This invention relates generally to radiofrequency (rf) cavities and couplers for applications in particle accelerators, pulsed rf power sources, amplifiers, mode converters and power couplers. In particular the invention relates to rf cavities and couplers that comprise rods to provide specified concentration of field patterns for the operating modes in the interaction region.

2. Description of Prior Art

A radiofrequency (rf) cavity is a microwave resonator that stores electromagnetic field energy within its metallic or dielectric boundaries. The geometric structure and material of the cavity determine the rf frequency and the electromagnetic field pattern of the modes sustainable in the cavity, as well as other figures of merit such as the quality factor Q, the shunt impedance R and R/Q. In applications where a particle beam interacts with the rf cavity as in particle accelerators or pulsed rf power amplifiers, the stored electromagnetic field in the cavity is coupled to the charge and current of a bunched particle beam which traverses through it. In addition, rf power may be supplied to or taken away from the rf cavity by means of waveguide(s) attached thereto.

A typical rf cavity is the “pillbox” cavity which generally takes the shape of a cylinder, with connecting tubes to allow a particle beam to pass through it, and/or waveguides to allow coupling to an external power source or a load. In a cylindrically symmetric cavity, the fundamental, or lowest rf frequency, TM010 mode of the cavity has electric fields parallel to the axis of the cavity and the particle beam, decaying to zero near the cavity walls. The boundary conditions of a perfect metallic, symmetric cavity demand that the electric field be normal to the cavity wall surface. Other variations of the pillbox cavity design exist in which cavity walls are cylindrically symmetric with no other members inside the walls. While a needle or rod with an adjustable penetration into an rf cavity has been used routinely to alter the properties of the cavity, such application in the past has the primary purpose of tuning the frequency of the cavity. Rods are also routinely used as antennas for transmitting electromagnetic energy into space. In addition to cylindrical rf cavities, rectangular cavities with a flat transverse electric field have also been designed. An example is the “barbell” cavity (Yu and Henke, U.S. Pat. No. 5,789,865). The fields of these cavities are likewise confined within the shaped cavity walls with no other members inside the walls.

In 1992, N. Kroll et al. proposed a new kind of rf cavities (N. Kroll, D. Smith, S. Shultz, Advanced Accelerator Concepts Workshop, Port Jefferson, N.Y., AIP Conf. Proc., v. 279, AIP 279 (1992) 197) by analogy with the photonic band gap (PBG) structures in solid state physics. The PBG rf cavity comprises a strictly regular array of rods forming a large rectangular or triangular lattice, in which a single rod is taken out. It was shown that the electromagnetic field of the fundamental mode of the PBG cavity at the location of the missing rod, or defect, in the infinite lattice is very similar to those in a pillbox cavity. It was further shown that unlike pillbox cavities, higher order modes could be suppressed in a PBG cavity by a proper choice of the rod dimension and inter-spacing between the rods in the cavity. Several schemes to couple rf power into finite PBG cavities were also proposed. The essential teaching of the PBG cavity was that the band gap structure of the modes in the PBG cavity relied on the properties of the lattice structure in which a single rod is missing. The PBG cavity in its original form is rather restrictive and has limited applications (Chen et al, U.S. Pat. No. 6,801,107).

What is thus desired is to provide a rod-loaded rf cavity with specified field concentration for the operating mode, in which the placement of a plurality of rods is not subject to the requirement of a large lattice, or the restriction of a singular defect as in a PBG structure.

### SUMMARY OF THE INVENTION

The devices in the present invention comprise a plurality (more than one) of rods in a confined space; the purpose of the rods is to shape or modify the electromagnetic fields in the confined space for specific applications. The confined space is defined by a cavity having metallic or dielectric walls. The rods are made of metal or dielectric material(s) with suitable cross section(s), with variable spacing between them, the choice of which depending on applications. The rods are attached to the end walls in the confined space. The end walls on opposite sides of the cavity wall and the side wall have openings to allow various other functions such as coupling of rf power, vacuum pumping and/or entrance and exit of the charged particle beams. In such cases the rods are generally arranged so that they are parallel to the direction of the charged particle beams. Each rod carries an rf current along its length producing a time varying magnetic field around it. The rods are grouped around the locations where a concentration of electromagnetic field is either required or dispensed with, depending on applications. For applications such as rf couplers and mode converters, the orientations and positions of the rods are chosen to shape the electromagnetic fields to achieve the intended purpose, for example, best transmission, or VSWR. When a charged particle is present, the orientations and positions of the rods in such cavities are chosen to achieve the maximum coupling between the electromagnetic field and the beam current. In order to take advantage of the additive effect of the fields around the rods, the rods are generally arranged with an azimuthal periodicity in at least one circle, or a linear periodicity in at least one row. In such case the distance between any two closest rods is normally the same. Variation of the inter-spacing between rods is used to change the electromagnetic coupling between cavities, and between the rod-loaded cavity and any external components such as a waveguide coupled to the cavity. The rf frequency, Q factor and R/Q of the rod-loaded cavity is determined by the material, shape and size of the cavity and those of each rod, as well as the inter-spacing between the rods. It is not necessary to have an infinite, or even a large array of rods in order to accomplish the intended purposes of the devices in the present invention. The primary purpose of the rods is to shape the electromagnetic fields inside the cavity for the intended purpose of an application.

In one aspect of the present invention, the electromagnetic field concentration for certain modes in a rod-loaded cavity is directed by the rods to a location or locations where the field is needed most for the intended application (for instance, electron acceleration), leaving other locations or regions of the cavity where the field is not needed with less field concentration.

In another aspect of the present invention, rods can be placed inside a large, overmoded cavity which can have external components attached to its peripheral wall without significantly altering the field pattern inside the cavity. Examples of such external components are pump ports, external rf waveguides, or diagnostic ports. The connection between some of these components and the cavity may include properly sized holes that either allow the required rf coupling between the cavity and external waveguides, or prevent the rf power in the cavity from transmitting into components such as the pump ports.

In another aspect of the present invention, the peripheral wall of the rod-loaded cavity may be lined with rf absorbers so that unwanted modes in the cavity are effectively damped.

In yet another aspect of the present invention, the rod-loaded cavity allows multiple charged particle beams to interact with the electromagnetic fields at multiple locations around which groups of rods are placed.

In yet still another aspect of the present invention, the rod-loaded cavity does not require a strictly regular lattice structure more than one order. The inter-spacing between rods may be either constant or variable in order for it to operate successfully for the intended applications.

In one aspect of the present invention, the cross section(s) of the rods in the rod-loaded rf cavity need not be restricted to a specific shape (e.g. circular), but may take on a variety of shapes such as ellipse, rectangle, polygon or any other suitable shape in order to shape the electromagnetic field for the intended application; nor do the cross sections need to be the same for all rods.

In another aspect of the present invention, the material(s) of the rods in the rod-loaded rf cavity need not be restricted to metal (e.g. copper), but can be dielectric as well in order to shape the electromagnetic field and to damp unwanted modes in the cavity for the intended application; nor do the materials need to be the same for all rods.

In yet another aspect of the present invention, the rods inside the cavity need not be placed at the vertices of a square or triangular lattice (as in a PBG cavity), but their pattern may be with or without any periodicity or repetition altogether in order to shape the electromagnetic field for the intended application.

In yet still another feature of the present invention, when the positions of rods do form a lattice-like pattern inside the cavity, a plurality of defects may be present at certain lattice points to allow passage of particle beams through such defects where rods are not present. There are many devices which can be constructed using patterns of multiple-rod groups inside rf cavities. A multiple-rod group placed around one or more locations inside an rf cavity enhances the electromagnetic field needed for single beam or multiple charged particle beams to interact with the rod-loaded cavity. Examples of multiple particle beam devices are multi-beam klystrons, sheet beam klystrons and multi-beam particle accelerators.

In the following several exemplary devices are described which illustrate the use of the rod-loaded cavities. Such examples include single- or multi-round-beam klystron or accelerator cavity, single- or multi-sheet-beam klystron or accelerator cavity, ring cavity for hollow beam, rf power coupler, mode converter, etc. These examples are for illustration only as many other devices can be constructed based on the principles and teachings of the present invention.

### DESCRIPTION OF DRAWINGS

For a better understanding of the present invention and further features thereof, reference is made to the following descriptions which are to be read in conjunction with the accompanying drawings wherein.

FIG. 1a illustrates an rf cavity loaded with rods, and with an optional layer of absorber lining the cavity wall;

FIG. 1b illustrates an rf cavity loaded with 3 rods and an external waveguide;

FIG. 2a shows two views of a cylindrical rf cavity loaded with 12 rods arranged in a single circle concentric with the cavity;

FIG. 2b illustrates a cylindrical rf cavity loaded with 12 rods and 3 external waveguides,

FIG. 3a shows two views of a cylindrical rf cavity loaded with 6 sets of rods, each set comprising 6 rods arranged in a single circle;

FIG. 3b illustrates a rod-loaded cavity with 6 sets of rods, each set comprising 6 rods arranged in a single circle, and a concentric, circular waveguide at the center of the cavity;

FIG. 4a illustrates two views of a planar rf cavity loaded with two rows of rods, providing a uniform field between the two rows of rods;

FIG. 4b illustrates two views of a planar rf cavity loaded with a single row of rods, providing uniform field between the rods and two sides of the cavity wall;

FIG. 5 illustrates two views of a rf cavity in a ring configuration, comprising two concentric circles of rods providing a uniform field between the two circles of rods;

FIG. 6a shows two views of a rod-loaded rf coupler that converts a TM01 mode in a circular waveguide, to a TE10 mode in a rectangular waveguide;

FIG. 6b illustrate a perspective view of the rod-loaded rf coupler shown in FIG. 6a;

FIG. 7a shows two views of a rod-loaded mode converter that converts a TM01 mode in a first circular waveguide, to a TM02 mode in a second circular waveguide whose axis is the same as that of the first waveguide;

FIG. 7b illustrates a perspective view of a rod-loaded TM01 to TM02 mode converter;

FIG. 8 illustrates the magnetic field pattern of the rod-loaded cavity shown in FIG. 1a;

FIG. 9a illustrates a trapped TM01 mode magnetic field pattern of the rod-loaded cavity shown in FIG. 2a,

FIG. 9b illustrates the relative Q values of the TM01 and TM11 modes in the rod-loaded cavity shown in FIG. 2a,

FIG. 10 illustrates the TM02 mode magnetic field pattern of the cylindrical rod-loaded cavity shown in FIG. 3b;

FIG. 11 illustrates the TM01 electric field pattern of the planar rod-loaded cavity shown in FIG. 4;

FIG. 12 illustrates the electric field pattern of the rod-loaded ring cavity shown in FIG. 5;

FIG. 13 illustrates the S parameter for transmission of an electromagnetic TM01 mode in the circular waveguide to a TE10 mode in the rectangular waveguide via the rod-loaded coupler shown in FIGS. 6a and 6b;

FIG. 14 illustrates the S parameter for transmission of an electromagnetic TM02 mode to a TM01 mode via the rod-loaded, mode converter shown in FIGS. 7a and 7b.

### DESCRIPTION OF THE INVENTION

The electromagnetic field distribution in free space is modified in the presence of metallic or dielectric materials. In this invention we exploit this property by placing metallic and/or dielectric rods inside a cavity with metallic walls, in order to provide field patterns for achieving specific goals. The metal cavity may be lined with an absorptive material, or be loaded with external waveguide to decrease the Q factor for the operating mode or higher order modes.

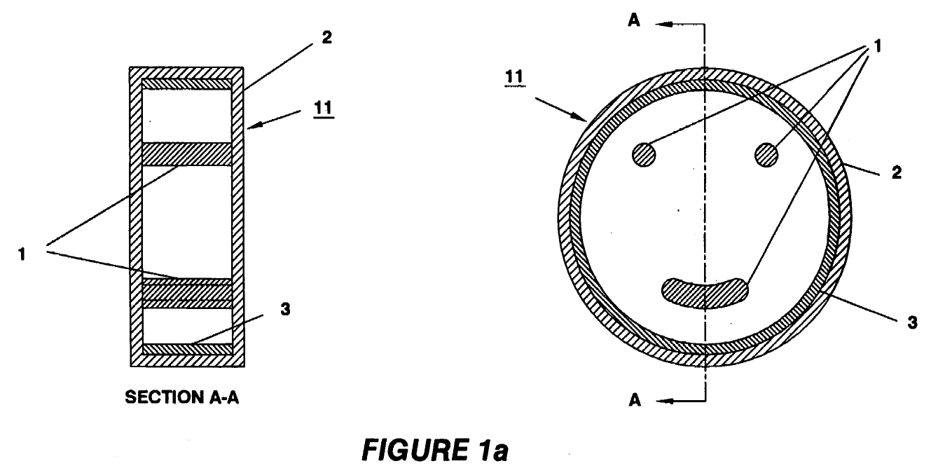

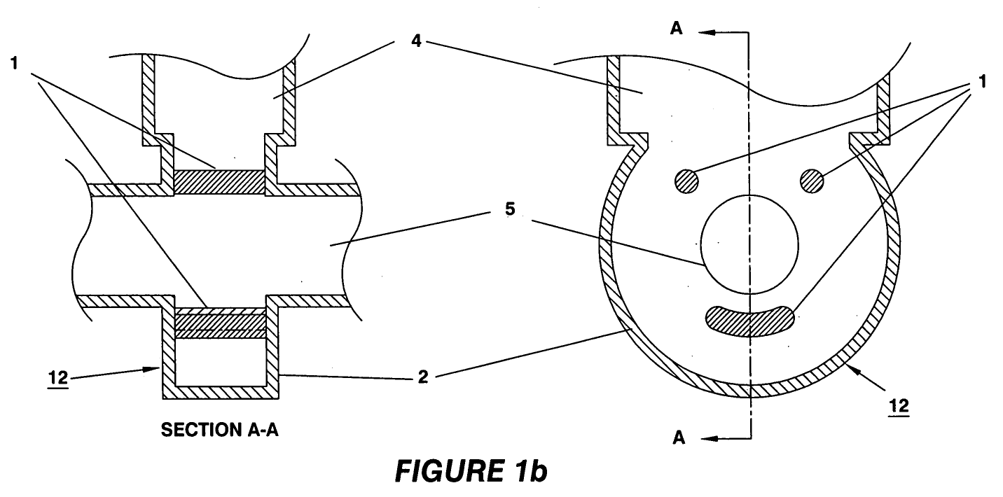

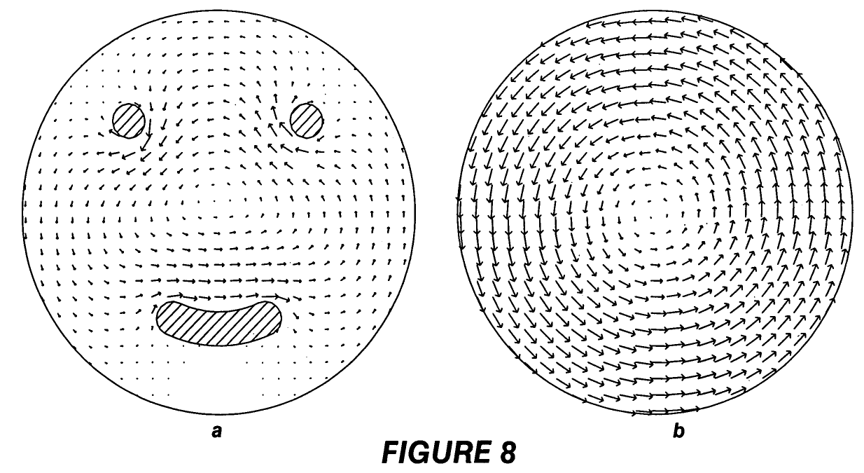

FIGS. 1a and 1b illustrate the general principles of this invention. FIG. 1a shows two views of a rod-loaded cavity 11 wherein three rods 1 of arbitrary shapes are placed inside a closed copper cylindrical shell 2. The presence of the rods 1 causes the magnetic field around the rods 1 to be modified from that without the rods 1. The resonance frequency of a cavity without rods is also changed when metallic rods are placed inside the cavity. The materials, shapes, locations and the number of rods 1, as well as the wall 2 of the cavity 11 in which rods 1 are placed can be chosen to suit applications. An rf absorber 3 such as Eccosorb may be placed on the inside of the cavity wall 2 in order to suppress peripheral fields and selectively decrease the Q values. The magnetic field of the rod-loaded cavity 11 of FIG. 1a is shown in FIG. 8a, having enhanced field concentration around the rods 1, as compared with that for the TM01 mode of a simple pillbox cavity (FIG. 8b). In the illustrated example, the radius of the 2 round rods is 0.19 cm, the distance from the cavity center to the rod center is 1.47 cm, and the radius of the cylindrical copper cavity is 2.3 cm. The frequency of the microwave cavity 11 is about 7 GHz, compared with about 5 GHz for a pillbox box cavity with a radius of 2.3 cm. The electromagnetic field of cavity 11 shown in FIG. 8a illustrates the local field enhancement in the presence of the 2 round rods and 1 shaped rod. FIG. 1b illustrates a rod-loaded cavity 12 with an external rectangular waveguide 4, used to couple rf power to selected electromagnetic modes in the cavity, and a circular waveguide 5, used either for the purpose of power coupling or for allowing the passage a charged particle beam which can couple with the electromagnetic field inside the cavity 12. As shown in FIG. 8a, the magnetic field of the rod-loaded cavity 11 is clearly different than that of a simple copper pillbox cavity (FIG. 8b). In particular, there is a higher concentration of magnetic field flux around the rods. Thus by placing round or shaped rods inside an rf cavity, it is possible to design a suitable electromagnetic field tailored for a specific application. In the following, several applications based on variations of the concept of rod-loaded cavity are described. These applications are described for the purpose of illustration only; and the general principle can be easily applied to other configurations and applications, with other materials, shapes, the number of rods and rod pattern, as well as the size, shape and number of external waveguides than those described, by following the teachings of the present invention. An example of an application using rod loaded cavities is set forth in application Ser. No. ______ entitled “A Symmetrized Coupler Converting Circular Waveguides TM01 Mode to Rectangular Waveguide TE10 Mode”, and filed concurrently herewith, the teachings of which that are necessary for the understanding of the present invention being incorporated herein by reference.

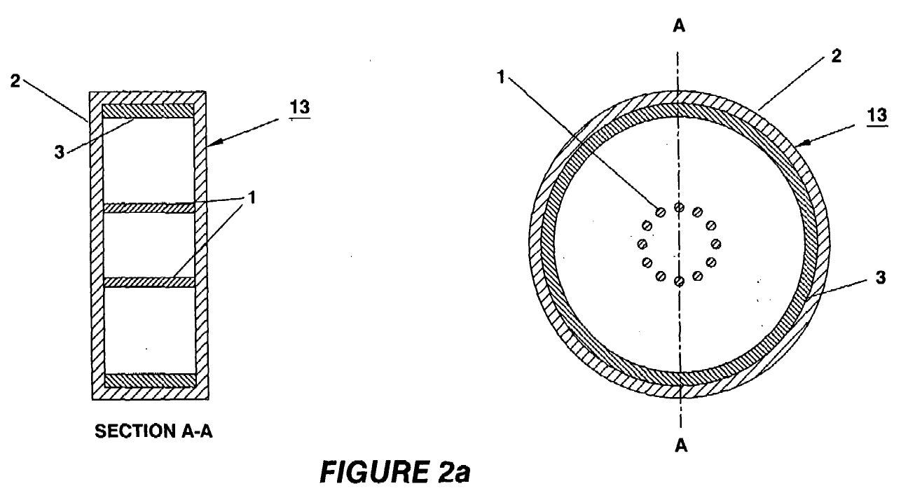

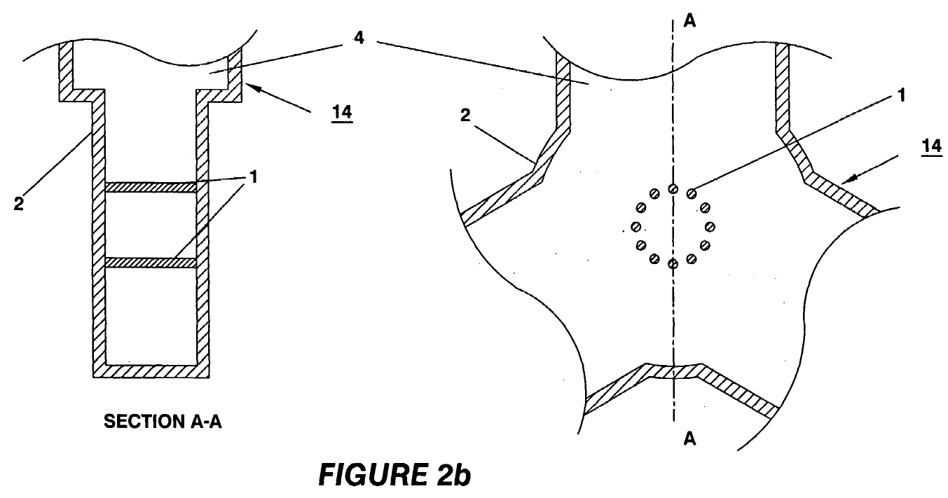

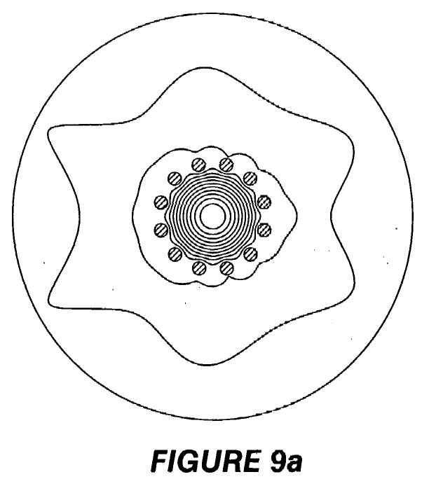

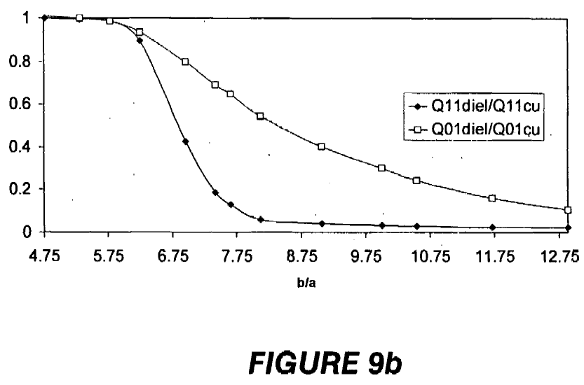

FIG. 2a shows two views of a cylindrical copper cavity 13 loaded with 12 round copper rods 1 arranged with equal spacing in a circular pattern. One purpose served by such a rod-loaded cavity 13 is that, by properly choosing the diameter (for example 0.128 cm as illustrated) of the rods 1, the distance (1.02 cm) from each rod center to the center of the cavity 13, and the number of rods 1, it is possible to use this structure to trap a desired mode (i.e. a TM010 mode) with a given resonant frequency f (≈12 GHz), quality factor Q and R/Q. As shown in FIG. 9a, the magnetic field of this mode is largely confined in the space enclosed by the circular pattern of rods 1. All other higher-order modes are untrapped, i.e. having a much lower Q. The energy of untrapped modes can be deposited into an absorber 3 (e.g. Eccosorb) lining the metal cavity wall 2, or coupled out with a single or a plurality of external waveguides 4 (see FIG. 2b).

FIG. 9b plots the relative Q values of the TM01 and TM11 modes versus the ratio of the distance (b) between the center of each rod 1 and the center of cavity 13, to the radius (a) of the rods in FIG. 2a. The ratio of the frequency of the TM11 mode to that of the TM01 is 1.6 for all values of b/a in this illustration. It is seen from FIG. 9b that in the range of 6.5<(b/a)<8.5, the value of the relative Q, defined as the ratio of the Q factor of a cavity with a perfect rf absorber at the cavity wall to that with a copper wall, is large for the TM01 mode relative to that for the TM11 mode. For these values of b/a, the rod-loaded cavity can be used a mode filter, or a higher-order mode suppressor, for vacuum electronics applications, such as microwave power tubes and charged particle accelerators. Multiple layers of concentric rings of rods can be used to further change the Q factors for better mode discrimination. In general the distance between any two rods 1 need not be the same for all adjacent pairs. Thus, a single-order, rod-loaded cavity 13 in the present invention manifests the essential characteristics of a much more complicated Photonic Band Gap (or PBG) cavity that requires a lattice of many layers of rods with equal spacing.

FIG. 2b shows an example of a rod-loaded cavity 14 coupled to a single or a plurality (3 in the case illustrated) of external waveguides 4. The waveguides 4 are used to couple electromagnetic energy stored in the cavity 14 to an external power source or an rf load.

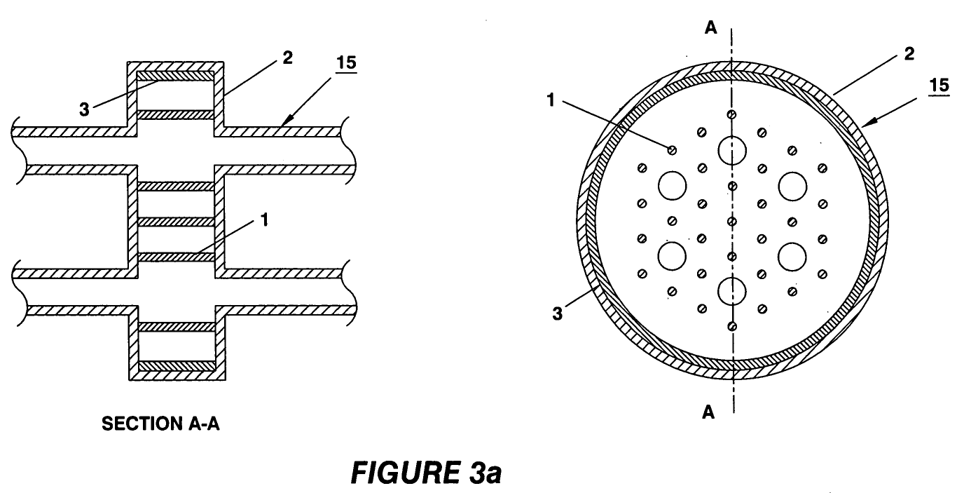

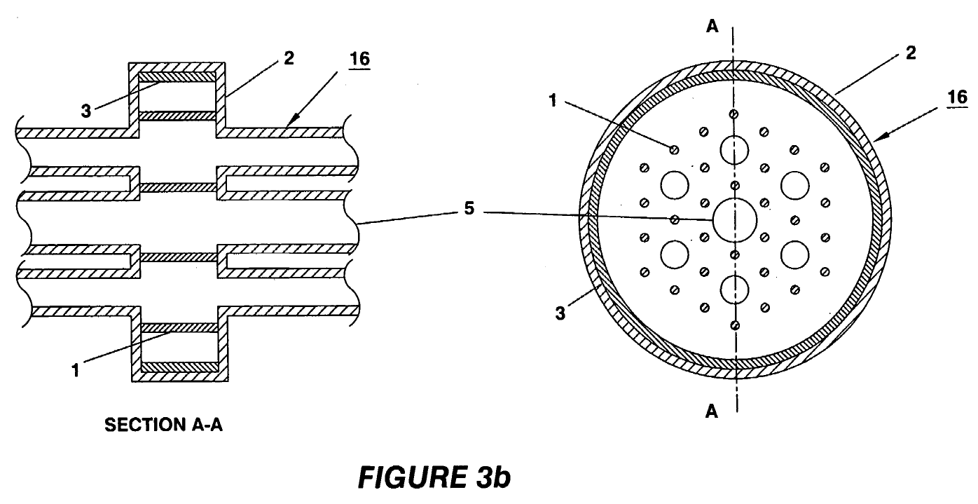

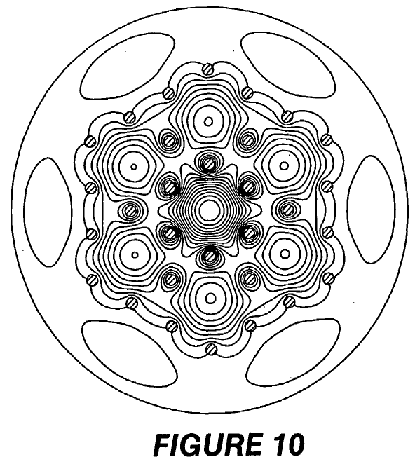

FIGS. 3a and 3b illustrate an rf cavity 15 (or 16) with 6 sets of rods 1, each set having a ring pattern of a plurality (6 for the case illustrated) of rods 1. As illustrated in the FIG. 3a, there are six circles of rods placed symmetrically around the center of the cavity 15. At the center of cavity 3a there is one additional rod. Cavity 15 in FIG. 3a has no external waveguide. Cavity 16 in FIG. 3b has no center rod, but instead has a central cylindrical waveguide 5 for external power coupling. Cavity wall 2 may be lined on the inside with an rf absorber 3 as needed to decrease the Q factor and enhance the performance of the cavity 15 or 16. Such a cylindrical, rod-loaded cavity 15 (or 16) can be used for multi-beam klystrons or multi-beam particle accelerators with a selected operating mode (e.g. TM010 mode). FIG. 10 shows the magnetic field of a global TM020-mode in a multi-center, rod-loaded cavity 16. More generally for multi-center, rod-loaded cavity 16 with the azimuthal periodic symmetry, the operating mode may be TM0n0, where n is an integer greater than 1. Modes with n>1 may be used in conjunction with a central waveguide 5 in FIG. 3b or peripheral waveguide(s) similar to that illustrated in FIG. 1b to couple the electromagnetic power between the rod loaded cavity 16 and an external power source or rf load. These applications are further described in detail in a separate patent application concurrently filed with the present one.

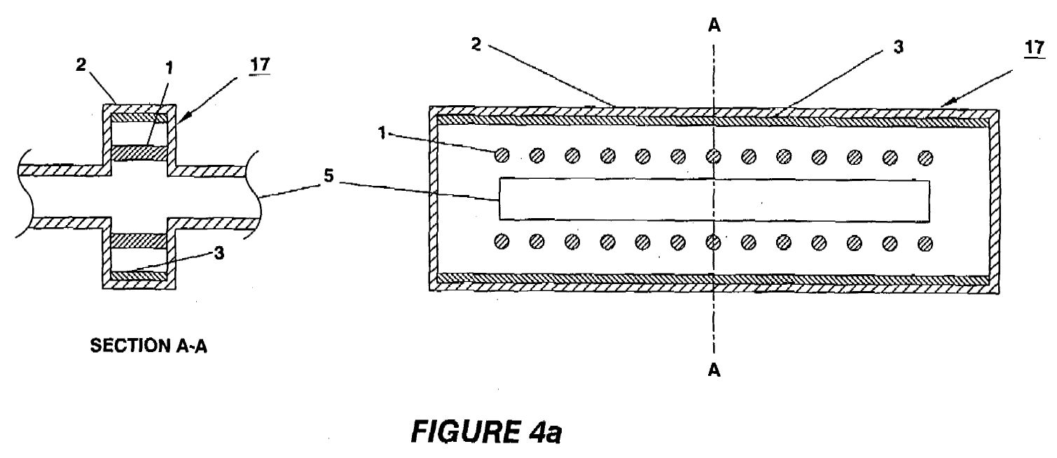

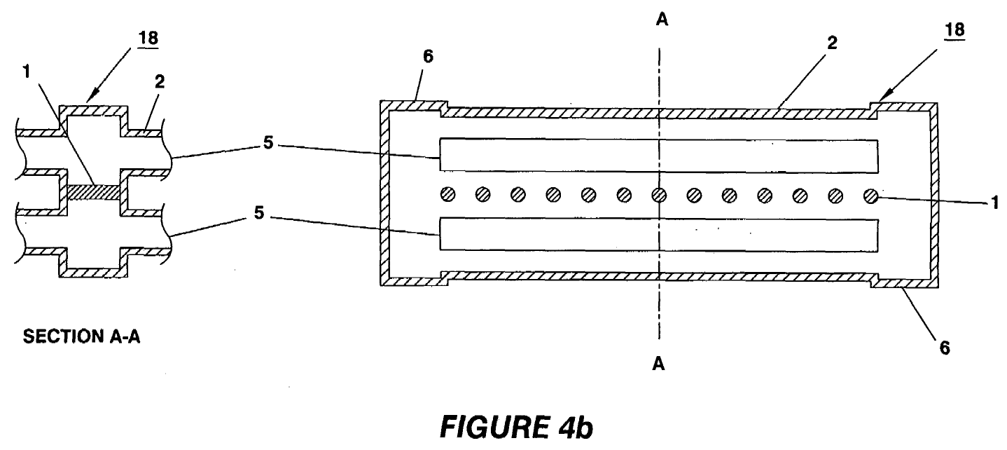

FIGS. 4a and 4b illustrate variations of the rod-loaded rf cavity wherein the rods arranged in a planar configuration. Instead of rods 1 being arranged in a ring pattern in a cylindrical cavity 2 as in FIG. 2a, here a single (or a plurality of) row(s) of rods 1 are present inside a rectangular cavity 17 (18). An rf absorber 3 may be placed on the inside of the cavity wall 2 as needed for mode damping. In FIG. 4a the fields are defined by two rows of rods 1. In FIG. 4b the fields are defined by a single row of rods 1 and the cavity wall 2. Rectangular waveguide(s) 5 may be connected to the central portion of the cavity 17, 18 to allow passage of particle beam or coupling of electromagnetic power to an external source of load. FIG. 4b shows that by using one row of rods 1 inside a planar, metallic cavity 18, two flat-field regions are formed between the cavity wall 2 and the row of rods 1. Thus cavity 18 allows coupling to two sheet beams simultaneously. The rod-loaded, planar cavities 17, 18 of FIGS. 4a and 4b can be easily modified to include a plurality (more than 2) of parallel rows of rods 1, thus increasing the number of regions in which flat electric fields may exist. Furthermore, FIG. 4b shows a modification of the simple rectangular cavity 17 by adding ears 6 on the sides of cavity 18. The use of ears 6 in a barbell-like cavity 18, is invoked for the purpose of providing a flat field with greater extent in the transverse dimension of the central part of the cavity 18.

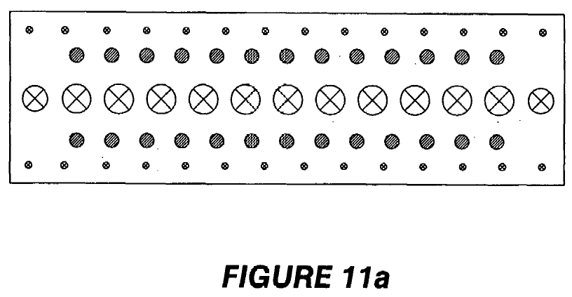

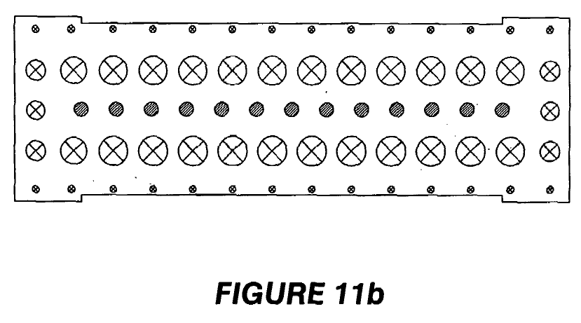

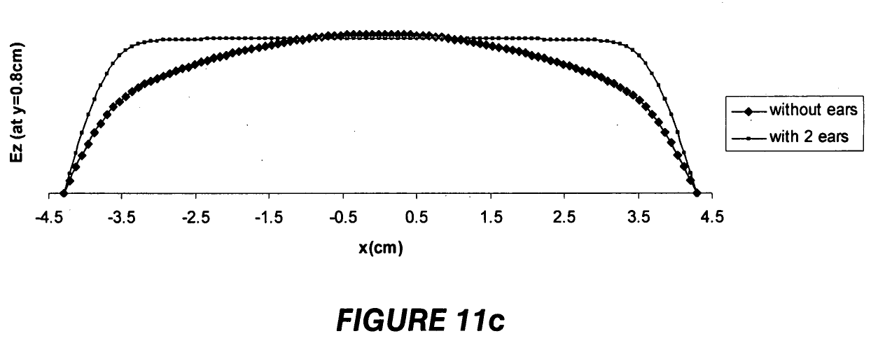

FIG. 11 compares the electric field of rod-loaded cavity 17, 18 with either a simple rectangular enclosure 2 or a barbell-like enclosure with ears 6. The electric field for cavity 17 and 18 is shown, respectively in FIG. 11a and FIG. 11b. FIG. 11c plots the electric field amplitude near the centerline in the interaction region versus the transverse dimension for cavity 17 and 18, with and without ears 6. The field amplitude is constant along a finite extent of the transverse dimension of the cavity 17, 18. With the added ears 6, the field flatness in cavity 18 can be designed to be as good that in other planar cavities such as the barbell cavity, using numerical simulation codes such as MAFIA or HFSS, or experimental procedures. Cavity 17, 18 may be used, for example, in a sheet-beam klystron or a sheet-beam particle accelerator. More details of rod-loaded, flat-field cavity 17, 18 are described in the above-mentioned concurrent patent application.

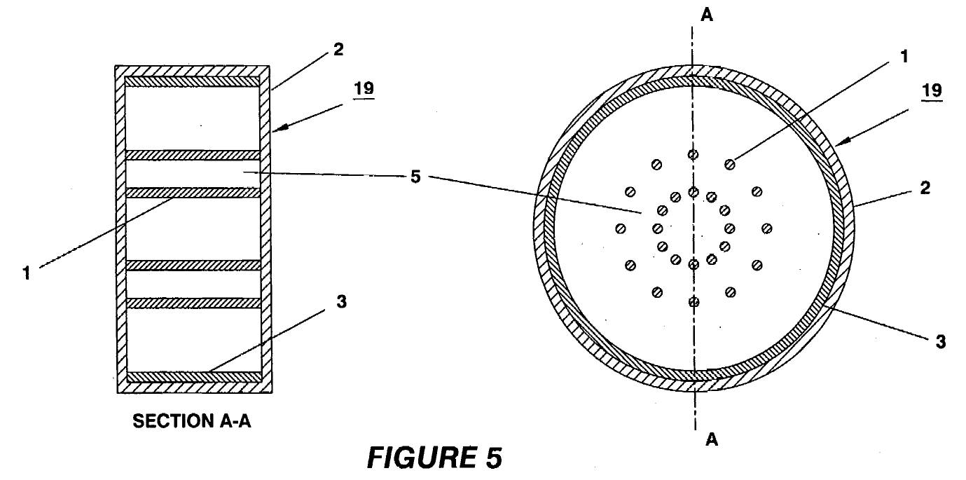

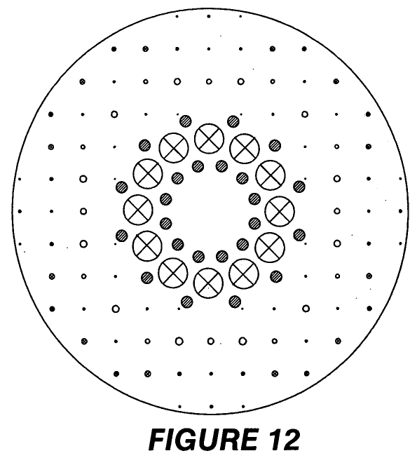

Still another variation of the rod-loaded rf cavity is illustrated in FIG. 5, in which rods 1 arranged in two concentric circles define an annular space 5 between the rods 1 to form a rod-load ring cavity 19. The electric field is constant near the mid circle between the two concentric sets of rods 1. The topology of rod-loaded ring cavity 19 may be formed by bending the linear array of rods 1 in rectangular cavity 17 of FIG. 4a, transforming two rows of rods 1 in cavity 17 into two concentric circles of rods, and placing the rods in a cylindrical cavity 19. The electric field pattern of the rod-loaded ring cavity 19 is shown in FIG. 12. Such a cavity can be used in a ring-beam klystron or a ring-beam accelerator. RF absorbers may be added to the ring cavity 19 as needed. Rectangular or circular waveguide(s) may also be added to cavity 19 for electromagnetic power coupling.

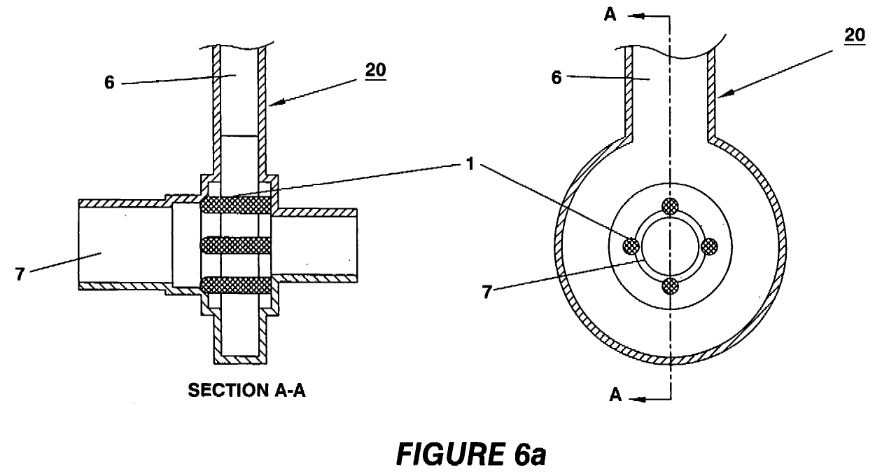

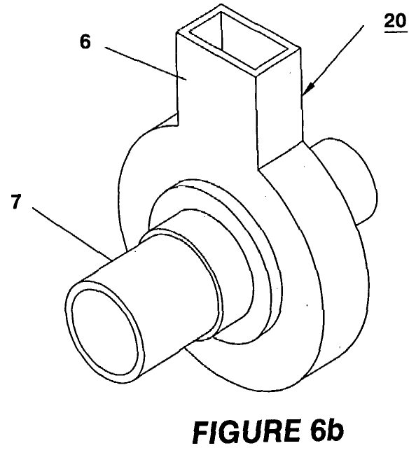

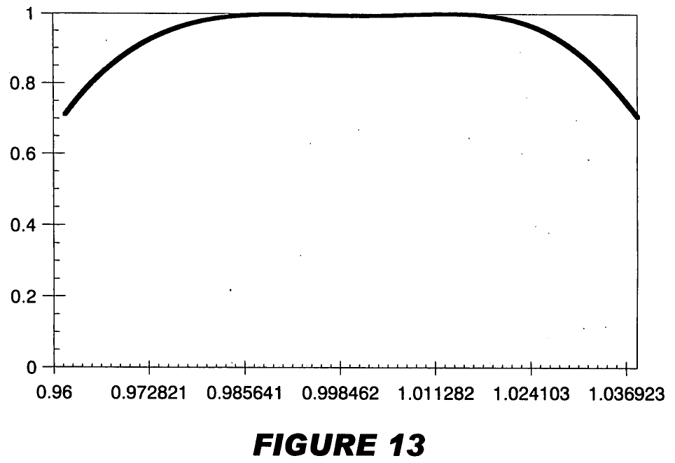

FIG. 6 illustrates yet another application of the rod-loaded rf structure, here as a mode converter 20 between a TM01-mode cylindrical waveguide 7 and a TE10-mode rectangular waveguide 6 having an axis perpendicular to that of the cylindrical waveguide 7. A plurality of rods 1 are placed inside the converter 20 to provide maximum transmission of rf power from the cylindrical waveguide 7 and the rectangular waveguide 6 shown in FIG. 6a. FIG. 6b is a perspective view of the mode converter 20. FIG. 13 shows the S-parameter, S12, computed with the CST Microwave Studio code, for transmission between the TM01 mode in the cylindrical waveguide 7 and the TE11 mode in the rectangular waveguide 6. The horizontal axis is the frequency of the incident or transmitted wave divided by the mid-band frequency of the mode converter. Further details of this mode converter are described in another patent application filed concurrently with the present one.

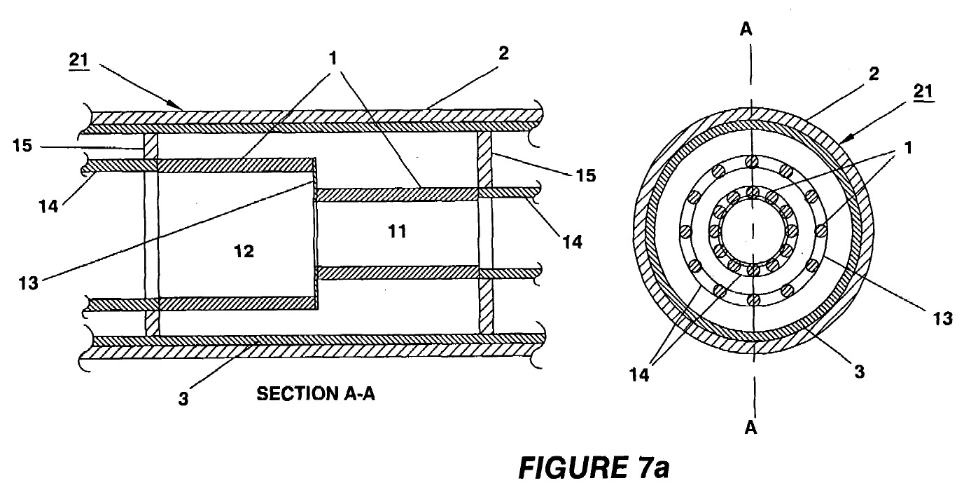

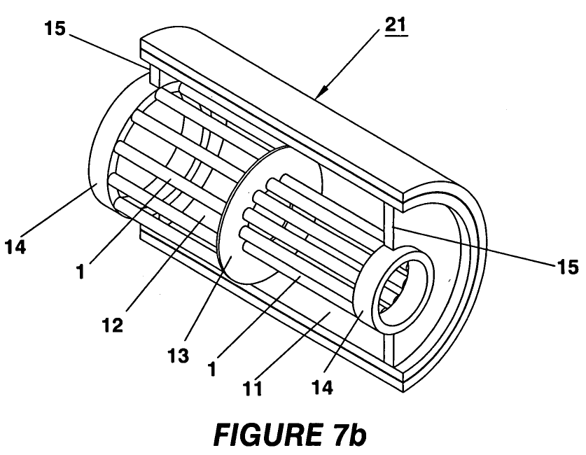

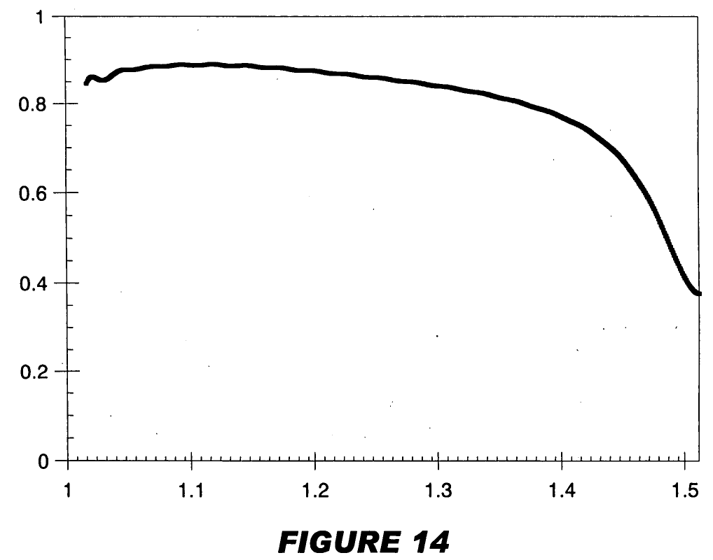

FIGS. 7a and 7b illustrates yet still another application of a rod-loaded structure, here as a mode converter 21 in which power initially propagating in a circular TM01 mode region 11 is converted to a TM02 circular mode having the same frequency in region 12. In each region where the respective modes propagate, rods 1 are arranged in a circular pattern that forms a leaky transmission line. The distance from the cavity center to the center of rods 1 is different in the two regions 11, 12, whereas the frequency of the two modes in regions 11, 12 is the same. The two sets of rods 1 in regions 11 and 12 are attached to a common, thin washer 13 as shown in FIGS. 7a and 7b. Cylindrical waveguides 14 may be attached to the ends of the rods 1 and used as mode launchers. Matching is provided by offsetting the inside surface of the cylindrical waveguides 14 with respect to the rods 1. The mode converter 21 has a metal housing 2, which may be lined with rf absorber 3 similar to other variants of rod-loaded structures heretoforth described, for the purpose of mode damping. Additional washers 15 may be used to provide mechanical support of the rods 1 and waveguides 14. Making use of the open space between the rods, the rod-loaded mode converter 21 can be easily pumped to ultra high vacuum for certain applications. Washers 13, 15 may be perforated, or replaced by rods to further improve pumping. FIG. 14 shows a typical S-parameter, S21 of the mode converter between the TM02 mode and the TM01 mode, calculated with the CST Microwave Studio code. The horizontal axis represents the frequency of the TM02 mode or the TM01 mode divided by the cutoff frequency of the TM02 mode waveguide.

What is claimed is:

1. A cavity for providing predetermined time-varying electromagnetic field patterns in said cavity comprising:
means for introducing radiofrequency power into said cavity;
means for introducing one or more charged particle beam(s) into said cavity;
means for introducing at least one port into said cavity in order to extract rf power from the electromagnetic field in said cavity, and other ports for vacuum pumping, beam diagnostics and functions necessary for the operation of said cavity;
a side wall having openings therein;
first and second end walls having openings therein;
first and second spaced apart rod members extending between said first and second end walls.

2. The cavity of claim 1 wherein said first rod member is fabricated from metal.

3. The cavity of claim 1 wherein said first rod member is fabricated from a dielectric material.

4. The cavity of claim 2 wherein said second rod member is fabricated from a dielectric material.

5. The cavity of claim 1 wherein said cavity side wall is cylindrical and said first and second rod members are arranged with an azimuthal periodicity in at least one circle.

6. The cavity of claim 1 wherein said cavity is rectangular and said first and second rod members are arranged with a linear periodicity in at least one row.

7. The cavity of claims 1 wherein said first and second rod members are arranged with no periodicity in the inter-spacing between said rods in any dimension.

8. The cavity of claims 1 wherein the numbers of first and second rod members are finite.

9. The cavity of claim 1 wherein the cross-section of said first and second rod members have a shape selected to produce a predetermined electromagnetic field generated within said cavity.

10. The cavity of claim 1 wherein the inter-spacing between said first and second rod members is selected to produce a predetermined electromagnetic field generated within said cavity.

11. The cavity of claim 1 wherein the current of a charged particle beam couples to said predetermined electromagnetic field within said cavity.

12. The cavity of claim 1 wherein the currents of multiple particle beams couple to said predetermined electromagnetic field within said cavity.

13. The cavity of claim 1 wherein said walls are lined with absorptive material to suppress peripheral fields.

14. The cavity of claim 1 wherein at least one waveguide is coupled to the cavity wherein electromagnetic energy stored therein is coupled to an external power source or an rf load.

15. The cavity of claim 1 wherein the spacing between said first and second rod members in a first mode of operation is a and b in a second mode operation, a being different from b.

16. The cavity of claim 1 wherein said side wall of said cavity is absent.

17. The cavity of claim 1 wherein primarily a single operating mode is present within the space adjacent to said first and second rod members.

18. The cavity of claim 1 wherein unwanted modes are not confined within said cavity.

19. A radiofrequency power coupler comprising the same means and structural members as the cavity of claim 1 and having at least two waveguides attached to said coupler, said electromagnetic field travels through said coupler and waveguides in space and time.

20. A radiofrequency transmission line comprising the same means and structural members as the cavity of claim 1 wherein said electromagnetic field travels in at least one mode through space and time within said transmission line.

21. A radiofrequency mode converter comprising the same means and structural members as the cavity of claim 1 wherein electromagnetic energy propagates in more than one mode through said converter.
